(19) United States
(12) Patent Application Publication
(10) Pub. No.: US 2007/0059552 A1
(43) Pub. Date: Mar. 15, 2007

(54) Organic electroluminescent device and complex compound

(75) Inventors: Akira Takeda, Kanagawa (JP); Tatsuya Igarashi, Kanagawa (JP)

Correspondence Address: SUGHRUE-265550, 2100 PENNSYLVANIA AVE. NW, WASHINGTON, DC, 20037-3213, US

(73) Assignee: FUJI PHOTO FILM CO., LTD.

(21) Appl. No.: 11/518,355

(22) Filed: Sep. 11, 2006

(30) Foreign Application Priority Data
Sep. 9, 2005 (JP) P2005-262305

(51) Int. Cl. B32B 19/00

(52) U.S. Cl. 428/690

(57) ABSTRACT

An organic electroluminescent device is provided and has at least one organic layer including a light-emitting layer between a pair of electrodes. The organic layer contains at least one compound represented by specific formula.

### BACKGROUND OF THE INVENTION

1. Field of the Invention

The present invention relates to an organic electroluminescent device which can emit light by converting electric energy into optical energy (hereinafter, also referred to as “organic EL device”, “light-emitting device”, or “device”), and to a complex compound.

2. Description of Background Art

Recently, various display devices have been intensively researched and developed, and an organic electroluminescent device (organic EL device) has been actively researched and developed among others because emission can be obtained with high luminance by driving at low voltage. Generally, the organic EL device includes an organic layer including a light-emitting layer and a pair of electrodes having the layer therebetween, and utilizes emission from an exciton generated by rebonding of an electron injected from a cathode and a hole injected from an anode in the light-emitting layer.

The efficiency of the device has been improved advancing in recent years by using phosphorescent material. As the phosphorescent material, iridium complexes and platinum complexes are known (For example, please refer to U.S. Pat. No. 6,303,238 and International Patent Publication No. 00/57676), and at present, there is a demand for the development of a phosphorescent material meeting both high efficiency and high durability.

### SUMMARY OF THE INVENTION

An object of an illustrative, non-limiting embodiment of the present invention is to provide a light-emitting device having high emission luminance, high luminous efficiency, and excellent durability. Another object of an illustrative, non-limiting embodiment of the present invention is to provide a complex compound which can be favorably used as the light-emitting device.

The above-mentioned object can be accomplished by the following means.

(1) An organic electroluminescent device comprising:

a pair of electrodes; and

at least one organic layer between the pair of electrode, the at least one organic layer including a light-emitting layer, wherein the at least.one organic layer contains at least one compound represented by formula (I): 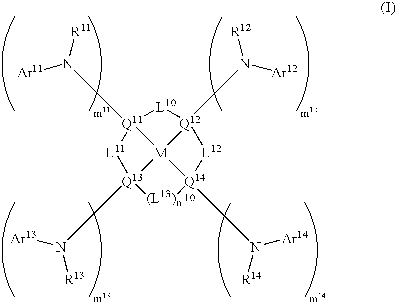
wherein M represents a metal ion; Q¹¹, Q¹², Q¹³, and Q¹⁴ each independently represent an atom group coordinating with M; L¹⁰, L¹¹, L¹², and L¹³ each independently represent a single bond, a double bond or a linking group; lines between the M and each of Q¹¹, Q¹², Q¹³, and Q¹⁴ represent one of a covalent bond, an ionic bond, and a coordinate bond; n¹⁰ is 0 or 1, and when n¹⁰=0, Q¹³ and Q¹⁴ do not bond to each other; m¹¹, m¹², m¹³ and m¹⁴ each independently are an integer of 0 or more, and at least one of m¹¹, m¹², m¹³ and m¹⁴ is 1 or more; Ar¹¹, Ar¹², Ar¹³ and Ar¹⁴ each independently represent an aryl group or a heteroaryl group; and R¹¹, R¹², R¹³, and R¹⁴ each independently represent a hydrogen atom or a substituent group.
(2) The organic electroluminescent device according to (1) above, wherein the metal ion represented by M in formula (I) is an ion selected from the group consisting of a platinum ion, an iridium ion, a rhenium ion, a palladium ion, a rhodium ion, a ruthenium ion, and a copper ion.
(3) The organic electroluminescent device according to (1) or (2) above, wherein the metal ion represented by M in formula (I) is an ion selected from the group consisting of a platinum ion, an iridium ion, a palladium ion, and a rhodium ion.
(4) The organic electroluminescent device according to any one of (1) to (3) above, wherein the substituent group in formula (I) is an alkyl group, an aryl group, or a heteroaryl group.
(5) The organic electroluminescent device according to any one of (1) to (4) above, wherein the compound represented by formula (I) is a compound represented by formula (II): 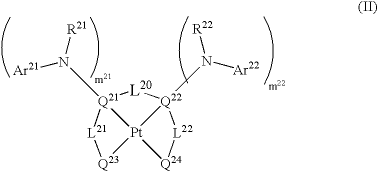
wherein Q²¹, Q²², Q²³, and Q²⁴ each independently represent an atom group coordinating with the platinum ion; L²⁰, L²¹, and L²² each independently represent a single bond, a double bond or a linking group; lines between the platinum ion and each of Q²¹, Q²², Q²³, and Q²⁴ represent one of a covalent bond, an ionic bond, and a coordinate bond; m²¹ and m²² each independently are an integer of 0 or more, and at least one of m²¹ and m²² is 1 or more; Ar²¹ and Ar²² each independently represent an aryl group or a heteroaryl group; and R²¹ and R²² each independently represent a hydrogen atom or a substituent group.
(6) The organic electroluminescent device according to (5) above, wherein the substituent group in formula (II) is an alkyl group, an aryl group, or a heteroaryl group.
(7) The organic electroluminescent device according to any one of (1) to (6) above, wherein the compound represented by formula (I) is a compound represented by formula (III): 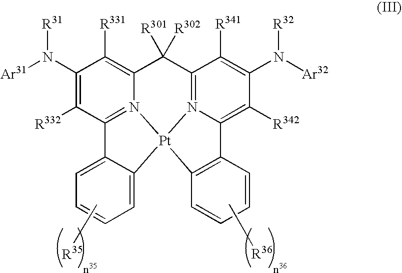
wherein lines between the platinum ion and the nitrogen atoms represent a coordinate bond; and lines between the platinum ion and the carbon atoms represent a covalent bond or an ionic bond; R³⁰¹ and R³⁰² each independently represent a hydrogen atom or a substituent group; Ar³¹ and Ar³² each independently represent an aryl group or a heteroaryl group; R³¹ and R³² each independently represent a hydrogen atom or a substituent group; R³³¹, R³³², R³⁴¹, and R³⁴² each independently represent a hydrogen atom or a substituent group; R³⁵ and R³⁶ independently each represent a substituent group; and n³⁵ and n³⁶ each independently represent an integer of 0 to 4.
(8) A compound represented by formula (III) described in (7) above.

### DETAILED DESCRIPTION OF THE EXEMPLARY EMBODIMENTS

Although the invention will be described below with reference to the exemplary embodiments thereof, the following exemplary embodiments and modifications do not restrict the invention.

A light-emitting device according to an exemplary embodiment is at least excellent in external quantum efficiency and high luminance. In addition, it is excellent in durability when specific substituent is provided. A complex compound according to an exemplary embodiment of the invention can be favorably used as a light-emitting device.

An organic electroluminescent device according to an exemplary embodiment of the invention (hereinafter, also referred to as “device of the invention”, includes at least one organic layer (it may be a layer formed of an organic compound, or an organic layer containing an inorganic compound) including a light-emitting layer, between a pair of electrodes, in which the organic layer placed between the pair of electrodes contains an optional compound represented by formula (I).

A compound represented by formula (I) will be described.

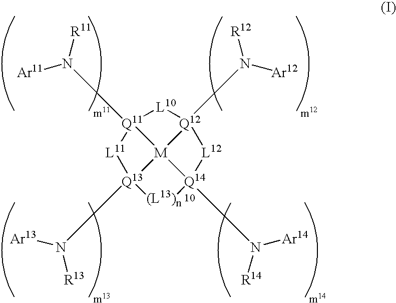

In formula (I), M represents a metal ion. The metal ion is not particularly limited, but is preferably a platinum ion, an iridium ion, a rhenium ion, a palladium ion, a rhodium ion, a ruthenium ion, a copper ion, an europium ion, a gadolinium ion, or a terbium ion, more preferably a platinum ion, an iridium ion, a rhenium ion, a palladium ion, a rhodium ion, a ruthenium ion, or a copper ion, even more preferably a platinum ion, an iridium ion, a palladium ion, or a rhenium ion, still more preferably a platinum ion or a iridium ion, and particularly preferably a platinum ion.

Q¹¹, Q¹², Q¹³, and Q¹⁴ each represent an atom group coordinating with M. An atom included in Q¹¹, Q¹², Q¹³, and Q¹⁴ and coordinating with M is preferably a nitrogen atom, an oxygen atom, a sulfur atom, or a carbon atom, and more preferably a nitrogen atom, an oxygen atom, or a carbon atom.

The bond formed between M and each of Q¹¹, Q¹², Q¹³, and Q¹⁴ may be a covalent bond, an ionic bond, or a coordinate bond. A ligand constituted by Q¹¹, L¹⁰, Q¹², L¹¹, Q¹³, L¹², Q¹⁴, and L¹³, is preferably an anionic ligand (of which at least one anion is bonded to metal). The number of anions among the anionic ligands is preferably from 1 to 3, more preferably 1 or 2, and even more preferably 2.

Q¹¹, Q¹², Q¹³, and Q¹⁴ of which a carbon atom coordinates with M are not particularly limited, and examples include an imino ligand, an aromatic carbon-ring ligand (for example, a benzene ligand, a naphthalene ligand, an anthracene ligand, a phenanthracene ligand, etc.), and a heterocyclic ligand (for example, a thiophene ligand, a pyridine ligand, a pyrazine ligand, a pyrimidine ligand, a thiazole ligand, an oxazole ligand, a pyrrole ligand, an imidazole ligand, condensed rings including them (for example, a quinoline ligand, a benzothiazole ligand, etc.), or tautomers thereof).

Q¹¹, Q¹², Q¹³, and Q¹⁴ of which a nitrogen atom coordinates with M are not particularly limited, and examples include a nitrogen-containing heterocyclic ligand {for example, a pyridine ligand, a pyrazine ligand, a pyrimidine ligand, a pyridazine ligand, a triazine ligand, a thiazole ligand, an oxazole ligand, a pyrrole ligand, an imidazole ligand, a pyrazole ligand, a triazole ligand, an oxadiazole ligand, a thiadiazole ligand, condensed rings including them (for example, a quinoline ligand, a benzooxazole ligand, a benzoimidazole ligand, etc.), or tautomers thereof}, an amino ligand {for example, an alkyl amino ligand (which has preferably 2 to 30 carbon atoms, more preferably 2 to 20 carbon atoms, and particularly preferably 2 to 10 carbon atoms, and examples include methylamino, and the like), an aryl amino ligand (examples include phenylamino, and the like), an acyl amino ligand (which has preferably 2 to 30 carbon atoms, more preferably 2 to 20 carbon atoms, and particularly preferably 2 to 10 carbon atoms, and examples include acetylamino, benzoylamino, and the like), an alkoxycarbonyl amino ligand (which has preferably 2 to 30 carbon atoms, more preferably 2 to 20 carbon atoms, and particularly preferably 2 to 12 carbon atoms, and examples include methoxycarbonylamino, and the like), an aryloxycarbonyl amino ligand (which has preferably 7 to 30 carbon atoms, more preferably 7 to 20 carbon atoms, and particularly preferably 7 to 12 carbon atoms, and examples include phenyloxycarbonylamino, and the like), a sulfonyl amino ligand (which has preferably 1 to 30 carbon atom(s), more preferably 1 to 20 carbon atom(s), and particularly preferably 1 to 12 carbon atom(s), and examples include methane sulfonylamino, benzene sulfonylamino, and the like)}, an imino ligand, and the like. Such ligands may be further substituted.

Q¹¹, Q¹², Q¹³, and Q¹⁴ of which an oxygen atom coordinates with M are not particularly limited, and examples include an alkoxy ligand (which has preferably 1 to 30 carbon atom(s), more preferably 1 to 20 carbon atom(s), and particularly preferably 1 to 10 carbon atom(s), and examples include methoxy, ethoxy, butoxy, 2-ethylhexyloxy, and the like), an aryloxy ligand (which has preferably 6 to 30 carbon atoms, more preferably 6 to 20 carbon atoms, and particularly preferably 6 to 12 carbon atoms, and examples include phenyloxy, 1-naphthyloxy, and 2-naphthyloxy), a heterocyclic oxy ligand (which has preferably 1 to 30 carbon atom(s), more preferably 1 to 20 carbon atom(s), and particularly preferably 1 to 12 carbon atom(s), and examples include pyridyloxy, pyradyloxy, pyrimidyloxy, quinolyloxy, and the like), an acyloxy ligand (which has preferably 2 to 30 carbon atoms, more preferably 2 to 20 carbon atoms, and particularly preferably 2 to 10 carbon atoms, and examples include acetoxy, benzoyloxy, and the like), a silyloxy ligand (which has preferably 3 to 40 carbon atoms, more preferably 3 to 30 carbon atoms, and particularly preferably 3 to 24 carbon atoms, and examples include trimethylsilyoxy, triphenylsilyloxy, and the like), a carbonyl ligand (for example, a ketone ligand, an ester ligand, an amide ligand, etc.), an ether ligand (for example, a dialkylether ligand, a diarylether ligand, a furyl ligand, etc.), and the like.

Q¹¹, Q¹², Q¹³, and Q¹⁴ of which a sulfur atom coordinates with M are not particularly limited, and examples include an alkylthio ligand (which has preferably 1 to 30 carbon atom(s), more preferably 1 to 20 carbon atom(s), and particularly preferably 1 to 12 carbon atom(s), and examples include methylthio, ethylthio, and the like), an arylthio ligand (which has preferably 6 to 30 carbon atoms, more preferably 6 to 20 carbon atoms, and particularly preferably 6 to 12 carbon atoms, and examples include phenylthio, and the like), a heterocyclic thio ligand (which has preferably 1 to 30 carbon atom(s), more preferably 1 to 20 carbon atom(s), and particularly preferably 1 to 12 carbon atom(s), and examples include pyridylthio, 2-benzimizolylthio, 2-benzoxazolylthio, 2-benzthiazolylthio, and the like); a thiocarbonyl ligand (for example, a thioketone ligand, a thioester ligand, etc.), a thioether ligand (for example, a dialkylthioether ligand, a diarylthioether ligand, a thiofuryl ligand, etc.), and the like. These substituent ligands may be further substituted.

Q¹³ and Q¹⁴ are preferably an aromatic carbon-ring ligand, an alkyloxy ligand, an aryloxy ligand, an ether ligand, an alkylthio ligand, an arylthio ligand, an alkylamino ligand, an arylamino ligand, an acylamino ligand, or a nitrogen-containing heterocyclic ligand (such as a pyridine ligand, a pyrazine ligand, a pyrimidine ligand, a pyridazine ligand, a triazine ligand, a thiazole ligand, an oxazole ligand, a pyrrole ligand, an imidazole ligand, a triazole ligand, an oxadiazole ligand, a thiadiazole ligand, condensed rings including them (for example, a quinoline ligand, a benzooxazole ligand, a benzimidazole ligand, etc.), or tautomers thereof); more preferably an aromatic carbon-ring ligand, an aryloxy ligand, an arylthio ligand, an arylamino ligand, a pyridine ligand, a pyrazine ligand, an imidazole ligand, condensed rings including them (for example, a quinoline ligand, a quinoxaline ligand, a benzimidazole ligand, etc.), or tautomers thereof; even more preferably an aromatic carbon-ring ligand, an aryloxy ligand, an arylthio ligand, or an arylamino ligand; and particularly preferably an aromatic carbon-ring ligand.

Q¹¹ and Q¹² are preferably a ligand forming a coordinate bond with M. The ligand forming a coordinate covalent bond with M is preferably a pyridine ring, a pyrazine ring, a pyrimidine ring, a triazine ring, a thiazole ring, an oxazole ring, a pyrrole ring, a triazole ring, condensed rings including them (for example, a quinoline ring, a benzooxazole ring, a benzimidazole ring, an indolenine ring, etc.), or tautomers thereof; more preferably a pyridine ring, a pyrazine ring, a pyrimidine ring, a pyrrole ring, condensed rings including them (for example, a quinoline ring, a benzopyrrole ring, etc.), or tautomers thereof, and even more preferably a pyridine ring, a pyrazine ring, a pyrimidine ring, or condensed rings including them (for example, a quinoline ring, etc.); and particularly preferably a pyridine ring and condensed rings including the pyridine ring (for example, a quinoline ring, etc.).

L¹⁰, L¹¹, L¹² and L¹³ represent a linking group, a single bond, or a double bond. The linking group is not particularly limited, and examples include a carbonyl linking group (—CO—), a thiocarbonyl linking group (—CS—), an alkylene group, an alkenylene group, an arylene group, a heteroarylene group, an oxygen atom linking group (—O—), a nitrogen atom linking group (i.e., a linking group containing a nitrogen atom), a silicon atom linking group (i.e., a linking group containing a silicon atom), and linking groups obtained by combining them.

L¹⁰, L¹¹, L¹² and L¹³ are preferably a single bond, a double bond, a carbonyl linking group, an alkylene linking group, or an alkenylene group, and L¹⁰ is more preferably a single bond or an alkylene group, and even more preferably an alkylene group. L¹¹ and L¹² are more preferably a single bond or an alkenylene group, and even more preferably a single bond. L¹³ is more preferably a single bond or an alkylene group, and even more preferably a single bond.

A ring formed by Q¹¹, L¹⁰, Q¹² and M, a ring formed by Q¹¹, L¹¹, Q¹³ and M, a ring formed by Q¹², L¹², Q¹⁴ and M, and a ring formed by Q¹³, L¹³, Q¹⁴ and M, are preferably a 4 to 10-membered ring, more preferably a 5 to 7-membered ring, and even more preferably a 5 or 6-membered ring.

n¹⁰ represent an integer of 0 or 1. When n¹⁰ is 0, Q¹³ and Q¹⁴ do not bond to each other to form a ring, and when n¹⁰ is 1, Q¹³ and Q¹⁴ bond to each other to form a ring. n¹⁰ is preferably 0.

R¹¹, R¹², R¹³, and R¹⁴ each independently represent a hydrogen atom or a substituent group. The substituent group is not particularly limited, and examples include an alkyl group (which has preferably 1 to 30 carbon atom(s), more preferably 1 to 20 carbon atom(s), and particularly preferably 1 to 10 carbon atom(s), and examples include methyl, ethyl, iso-propyl, tert-butyl, n-octyl, n-decyl, n-hexadecyl, cyclopropyl, cyclopentyl, cyclohexyl, and the like), an alkenyl group (which has preferably 2 to 30 carbon atoms, more preferably 2 to 20 carbon atoms, and particularly preferably 2 to 10 carbon atoms, and examples include vinyl, aryl, 2-butenyl, 3-pentenyl, and the like), an alkynyl group (which has preferably 2 to 30 carbon atoms, more preferably 2 to 20 carbon atoms, and particularly preferably 2 to 10 carbon atoms, and examples include propargyl, 3-pentinyl, and the like), an aryl group (which has preferably 6 to 30 carbon atoms, more preferably 6 to 20 carbon atoms, and particularly preferably 6 to 12 carbon atoms, and examples include phenyl, p-methylphenyl, naphthyl, anthranil, and the like), an amino group (which has preferably 0 to 30 carbon atom(s), more preferably 0 to 20 carbon atom(s), and particularly preferably 0 to 10 carbon atom(s), and examples include amino, methyl amino, dimethyl amino, diethyl amino, dibenzyl amino, diphenyl amino, ditolyl amino, and the like), an alkoxy group (which has preferably 1 to 30 carbon atom(s), more preferably 1 to 20 carbon atom(s), and particularly preferably 1 to 10 carbon atom(s), and examples include methoxy, ethoxy, butoxy, 2-ethylhexyloxy, and the like), an aryloxy group (which has preferably 6 to 30 carbon atoms, more preferably 6 to 20 carbon atoms, and particularly preferably 6 to 12 carbon atoms, and examples include phenyloxy, 1-naphthyloxy, 2-naphthyloxy, and the like), a heterocyclic oxy group (which has preferably 1 to 30 carbon atom(s), more preferably 1 to 20 carbon atom(s), and particularly preferably 1 to 12 carbon atom(s), and examples include pyridyloxy, pyradyloxy, pyrimidyloxy, quinolyloxy, and the like), an acyl group (which has preferably 1 to 30 carbon atom(s), more preferably 1 to 20 carbon atom(s), and particularly preferably 1 to 12 carbon atom(s), and examples include acetyl, benzoyl, formyl, pivaloyl, and the like), an alkoxycarbonyl group (which has preferably 2 to 30 carbon atoms, more preferably 2 to 20 carbon atoms, and particularly preferably 2 to 12 carbon atoms, and examples include methoxycarbonyl, ethoxycarbonyl, and the like), an aryloxycarbonyl group (which has preferably 7 to 30 carbon atoms, more preferably 7 to 20 carbon atoms, and particularly preferably 7 to 12 carbon atoms, and examples include phenyloxycarbonyl, and the like), an acyloxy group (which has preferably 2 to 30 carbon atoms, more preferably 2 to 20 carbon atoms, and particularly preferably 2 to 10 carbon atoms, and examples include acetoxy, benzoyloxy, and the like), an acyl amino group (which has preferably 2 to 30 carbon atoms, more preferably 2 to 20 carbon atoms, and particularly preferably 2 to 10 carbon atoms, and examples include acetyl amino, benzoyl amino, and the like), an alkoxycarbonyl amino group (which has preferably 2 to 30 carbon atoms, more preferably 2 to 20 carbon atoms, and particularly preferably 2 to 12 carbon atoms, and examples include methoxycarbonyl amino, and the like), an aryloxycarbonyl amino group (which has preferably 7 to 30 carbon atoms, more preferably 7 to 20 carbon atoms, and particularly preferably 7 to 12 carbon atoms, and examples include phenyloxycarbonyl amino, and the like), a sulfonyl amino group (which has preferably 1 to 30 carbon atom(s), more preferably 1 to 20 carbon atom(s), and particularly preferably 1 to 12 carbon atom(s), and examples include methane sulfonyl amino, benzene sulfonyl amino, and the like), a sulfamoyl group (which has preferably 0 to 30 carbon atom(s), more preferably 0 to 20 carbon atom(s), and particularly preferably 0 to 12 carbon atom(s), and examples include sulfamoyl, methylsulfamoyl, dimethylsulfamoyl, phenylsulfamoyl, and the like), a carbamoyl group (which has preferably 1 to 30 carbon atom(s), more preferably 1 to 20 carbon atom(s), and particularly preferably 1 to 12 carbon atom(s), and examples include carbamoyl, methylcarbamoyl, diethylcarbamoyl, phenylcarbamoyl, and the like), an alkylthio group (which has preferably 1 to 30 carbon atom(s), more preferably 1 to 20 carbon atom(s), and particularly preferably 1 to 12 carbon atom(s), and examples include methylthio, ethylthio, and the like), an arylthio group (which has preferably 6 to 30 carbon atoms, more preferably 6 to 20 carbon atoms, and particularly preferably 6 to 12 carbon atoms, and examples include phenylthio, and the like), a heterocyclic thio group (which has preferably 1 to 30 carbon atom(s), more preferably 1 to 20 carbon atom(s), and particularly preferably 1 to 12 carbon atom(s), and examples include pyridylthio, 2-benzimizolylthio, 2-benzoxazolylthio, 2-benzthiazolylthio, and the like), a sulfonyl group (which has preferably 1 to 30 carbon atom(s), more preferably 1 to 20 carbon atom(s), and particularly preferably 1 to 12 carbon atom(s), and examples include mesyl, tosyl, and the like), a sulfinyl group (which has preferably 1 to 30 carbon atom(s), more preferably 1 to 20 carbon atom(s), and particularly preferably 1 to 12 carbon atom(s), and examples include methane sulfinyl, benzene sulfinyl, and the like), an ureido group (which has preferably 1 to 30 carbon atom(s), more preferably 1 to 20 carbon atom(s), and particularly preferably 1 to 12 carbon atom(s), and examples include ureido, methylureido, phenylureido, and the like), an amide phosphate group (which has preferably 1 to 30 carbon atom(s), more preferably 1 to 20 carbon atom(s), and particularly preferably 1 to 12 carbon atom(s), and examples include diethyl amide phosphate, phenyl amide phosphate, and the like), a hydroxy group, a mercapto group, a halogen atom (for example, a fluorine atom, a chlorine atom, a bromine atom, and an iodine atom), a cyano group, a sulfo group, a carboxyl group, a nitro group, a hydroxamic group, a sulfino group, a hydrazino group, an imino group, a heterocyclic group (which has preferably 1 to 30 carbon atom(s) and more preferably 1 to 12 carbon atom(s), and examples of the hetero atom includes a nitrogen atom, an oxygen atom, and a sulfur atom, and specific examples include imidazolyl, pyridyl, quinolyl, furyl, thienyl, piperidyl, morpholino, benzoxazolyl, benzimidazolyl, benzthiazolyl, a carbazolyl group, an azepinyl group, and the like), a silyl group (which has preferably 3 to 40 carbon atoms, more preferably 3 to 30 carbon atoms, and particularly preferably 3 to 24 carbon atoms, and examples include trimethylsilyl, triphenylsilyl, and the like), a silyloxy group (which has preferably 3 to 40 carbon atoms, more preferably 3 to 30 carbon atoms, and particularly preferably 3 to 24 carbon atoms, and examples include methylsilyloxy, triphenylsilyloxy, and the like), and the like. The substituent is preferably an alkyl group, an alkenyl group, an acyl group, an alkoxycarbonyl group, an aryloxycarbonyl group, a carbamoyl group, an amide phosphate group, a silyl group, an aryl group, or a heteroaryl group; more preferably an alkyl group, an acyl group, an alkoxycarbonyl group, an aryloxycarbonyl group, a carbamoyl group, a silyl group, an aryl group, or a heteroaryl group; and particularly preferably an alkyl group, an aryl group, or a heteroaryl group. These substituent groups may be further substituted. The substituent may include a polymer chain and may be single bond(s) so that the compound of formula (I) can be a polymer compound.

Ar¹¹, Ar¹², Ar¹³, and Ar¹⁴ each independently represent an aryl group or a heteroaryl group. The aryl group or the heteroaryl group are not particularly limited, and for example, the aryl group has preferably 6 to 30 carbon atoms, more preferably 6 to 20 carbon atoms, even more preferably 6 to 12 carbon atoms, and examples include phenyl, p-methylphenyl, naphthyl, anthranil, and the like, and the heteroaryl group has preferably 1 to 30 carbon atom(s) and more preferably 1 to 12 carbon atom(s), and examples of the hetero atom include a nitrogen atom, an oxygen atom, and a sulfur atom, and specific examples include an imidazolyl group, a pyridyl group, a quinolyl group, a furyl group, a thienyl group, a piperidyl group, a morpholino group, a benzoxazolyl group, a benzimidazolyl group, a benzthiazolyl group, a carbazolyl group, an azepinyl group, and the like. Ar¹¹, Ar¹², Ar¹³, and Ar¹⁴ are preferably an anthranil group, a naphthyl group, a phenyl group, a pyridyl group, a quinolyl group, or a carbazolyl group; more preferably a naphthyl group, a phenyl group, a pyridyl group, or a quinolyl group; and particularly preferably a phenyl group.

When R¹¹, R¹², R¹³, and R¹⁴ are not a hydrogen atom, Ar¹¹ and R¹¹, Ar¹² and R¹², Ar¹³ and R¹³, or Ar¹⁴ and R⁴, may be bonded to each other to form a ring. A ring formed by Ar¹¹, R¹¹ and a nitrogen atom, a ring formed by Ar¹², R¹² and a nitrogen atom, a ring formed by Ar¹³, R¹³ and a nitrogen atom, and a ring formed by Ar¹⁴, R¹⁴ and a nitrogen atom, are preferably a 4 to 10-membered ring, more preferably a 5 to 7-membered ring, and even more preferably a 5 to 6-membered ring (for example, a pyrrole ring, a pyrrolidine ring, a piperidine ring, etc.).

Ar¹¹, Ar¹², Ar¹³, and Ar¹⁴ may be respectively bonded to Q¹¹, Q¹², Q¹³, and Q¹⁴ to form a ring, and when R¹¹, R¹², R¹³, and R¹⁴ are not a hydrogen atom, R¹¹, R¹², R¹³, and R¹⁴ may be respectively bonded to Q¹¹, Q¹², Q¹³, and Q¹⁴ to form a ring. Rings respectively formed by Ar¹¹ and Q¹¹, Ar¹² and Q¹², Ar¹³ and Q¹³, Ar¹⁴ and Q¹⁴, R¹¹ and Q¹¹, R¹² and Q¹², R¹³ and Q¹³, and R¹⁴ and Q¹⁴, with a nitrogen atom, are preferably a 4 to 10-membered ring, more preferably a 5 to 7-membered ring, and even more preferably a 6-membered ring.

m¹¹, m¹², m¹³, and m¹⁴ are an integer of 0 to 20 and at least one of which is not 0, preferably, m¹¹ and m¹² are from 1 to 3 and m¹³ and m¹⁴ are 0, and more preferably, m¹¹ and m¹² are 1 and m¹³ and m¹⁴ are 0.

The compound represented by formula (I) is preferably a compound represented by formula (II).

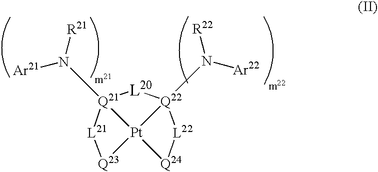

The compound represented by formula (II) will be described.

Q²¹, Q²², Q²³ and Q²⁴ have the same meaning as defined in the above Q¹¹, Q¹², Q¹³ and Q¹⁴, respectively, and preferable ranges thereof are also similar thereto.

L²⁰, L²¹, and L²² have the same meaning as defined in the above L¹⁰, L¹¹, and L¹², respectively, and preferable ranges thereof are also similar thereto.

R²¹ and R²² have the same meaning as defined in the above R¹¹ and R¹², respectively, and preferable ranges thereof are also similar thereto.

Ar²¹ and Ar²² have the same meaning as defined in the above Ar¹¹ and Ar¹², respectively, and preferable ranges thereof are also similar thereto.

m²¹ and m²² have the same meaning as defined in the above m¹¹ and m¹², respectively, and preferable ranges thereof are also similar thereto.

The compound represented by formula (I) or formula (II) is preferably a compound represented by formula (III).

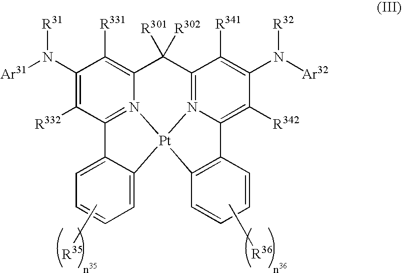

R³⁰¹ and R³⁰² each independently represent a hydrogen atom or a substituent group. The substituent group can be selected from the above-mentioned groups listed as the examples of R¹¹ to R¹⁴. R³⁰¹ and R³⁰² are preferably an alkyl group, an aryl group, a heteroaryl group, a cyano group, or a hydrogen atom, more preferably an alkyl group or an aryl group, and particularly preferably a methyl group or a phenyl group.

R³⁰¹ and R³⁰² may be bonded to each other to form a ring, and thus-formed ring is preferably a 3 to 8-, and more preferably a 5 to 6-membered ring.

R³¹ and R³² have the same meaning as defined in the above R²¹ and R²², respectively, preferable ranges thereof are also similar thereto, and are preferably a phenyl group, or a methyl group.

Ar³¹ and Ar³² have the same meaning as defined in the above Ar²¹ and Ar²², respectively, and preferable ranges thereof are also similar thereto.

When R³¹ and R³² are not a hydrogen atom, Ar³¹ and R³¹, and Ar³² and R³², may be bonded to each other to respectively form a ring. A ring formed by Ar³¹, R³¹ and a nitrogen atom, and a ring formed by Ar³², R³², and a nitrogen atom, are preferably a 4 to 10-membered ring, more preferably a 5 to 7-membered ring, and even more preferably a 5 or 6-membered ring (for example, an indole ring, an isoindole ring, an indoline ring, a carbazole ring, a quinoline ring, an isoquinoline ring, etc.).

R³³¹, R³³², R³⁴¹ and R³⁴² each independently represent a hydrogen atom or a substituent group. The substituent group can be selected from the above-mentioned groups listed as the examples of R¹¹ to R¹⁴. R³³¹, R³³², R³⁴¹ and R³⁴² are preferably a hydrogen atom, an alkyl group, or an amino group, more preferably a hydrogen atom or an alkyl group, and even more preferably a hydrogen atom.

When R³³¹, R³³², R³⁴¹ and R³⁴² are not a hydrogen atom, R³³¹ and R³³² may be bonded to R³¹ and Ar³¹ to form a ring, and R³⁴¹ and R³⁴² may be bonded to R³² and Ar³² to form a ring. Thus-formed rings are preferably a 5 to 8-membered ring, and more preferably a 6-membered ring.

R³⁵ and R³⁶ each independently represent a hydrogen atom or a substituent group. The substituent group can be selected from the above-mentioned groups listed as the examples of R¹¹ to R¹⁴. R^{35 and R}³⁶ are preferably a halogen atom, a cyano group, an aryl group, or a hydrogen atom, more preferably a halogen atom, a cyano group, a phenyl group, or a hydrogen atom, and even more preferably a fluorine atom, a cyano group, or a hydrogen atom.

n³⁵ and n³⁶ are an integer of 0 to 4, and preferably 1 to 3. When a plurality of R³⁵ and R³⁶ are provided, the plurality of R³⁵ and R³⁶ may be same with or different from each other, and bonded to each other to form a ring (for example, a fused benzene ring, a fused pyridine ring, a fused pyrrole ring, a fused furan ring, etc.).

Functions of the compound represented by formula (I) according to an exemplary embodiment of the invention are not particularly limited and may be contained in any layers in the organic layer. It is preferably contained in any one of a hole injecting layer, a hole transport layer, a light-emitting layer, an electron transport layer, an electron injecting layer, an exciton blocking layer and a charge blocking layer, or in many of those layers. It is more preferably contained in the light-emitting layer, and particularly preferably contained as a light-emitting material in the light-emitting layer.

Specific examples of the compound represented by formula (I) are illustrated below, however the present invention is not limited thereto.

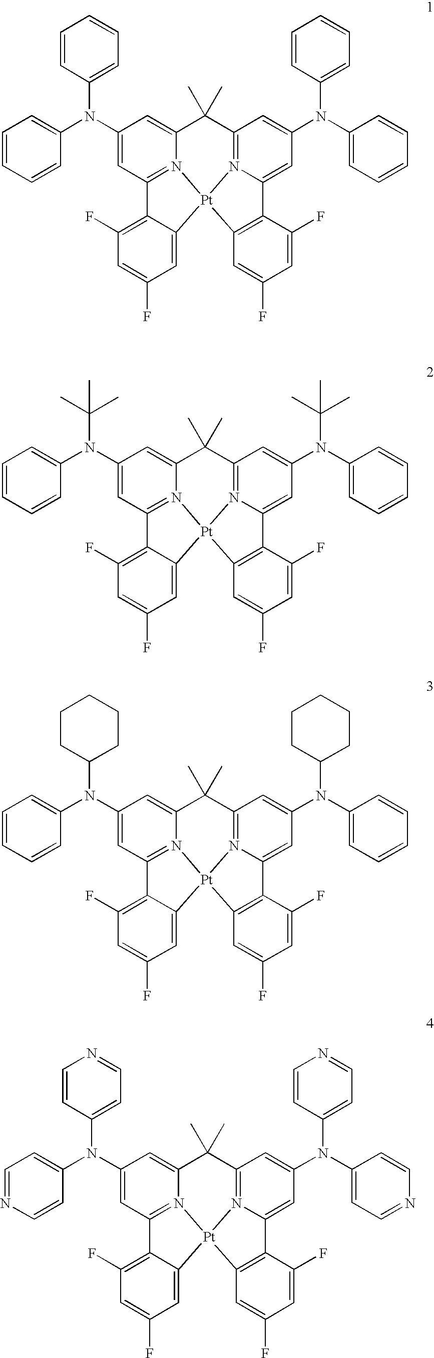

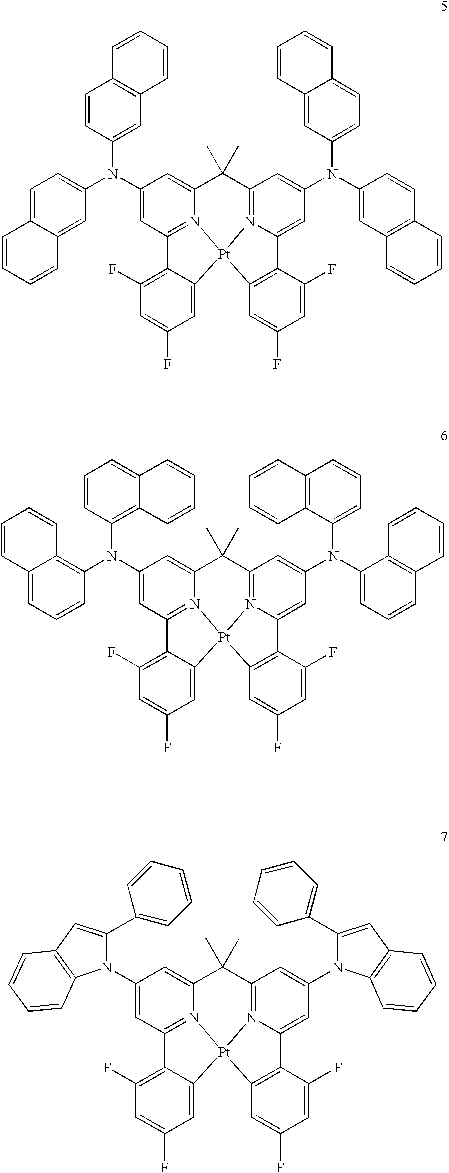

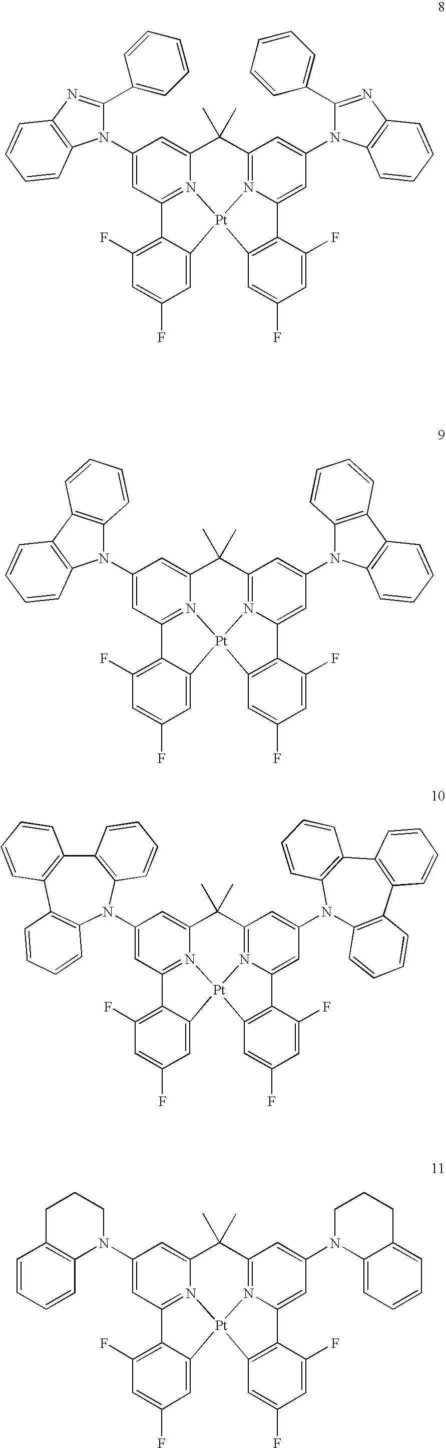

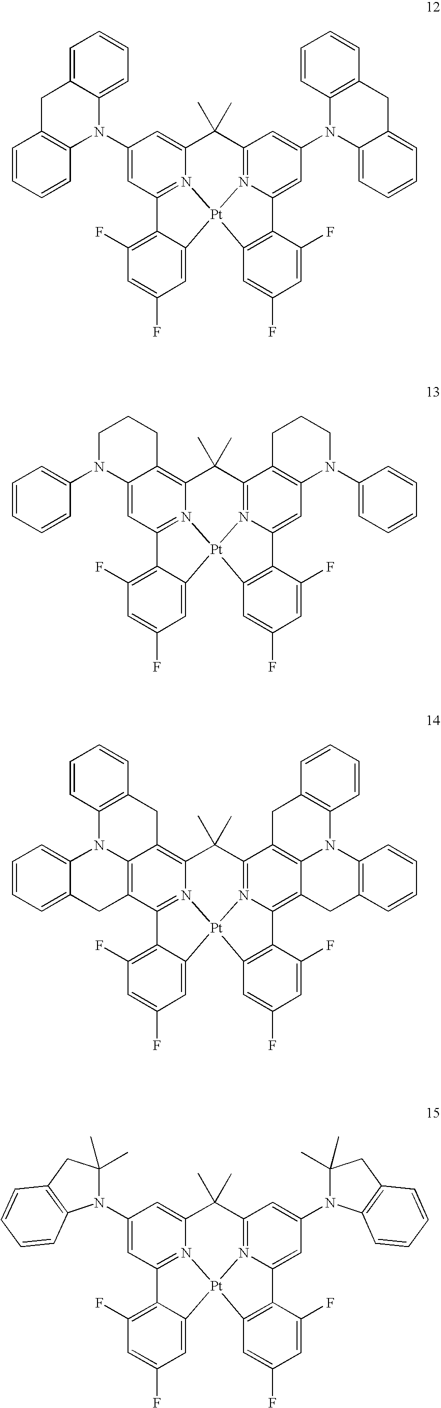

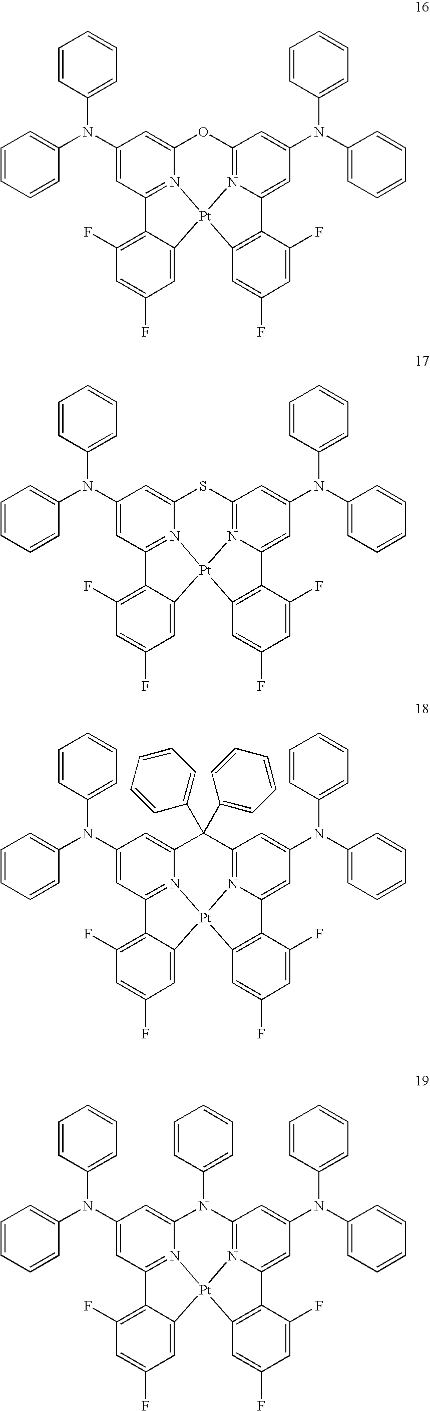

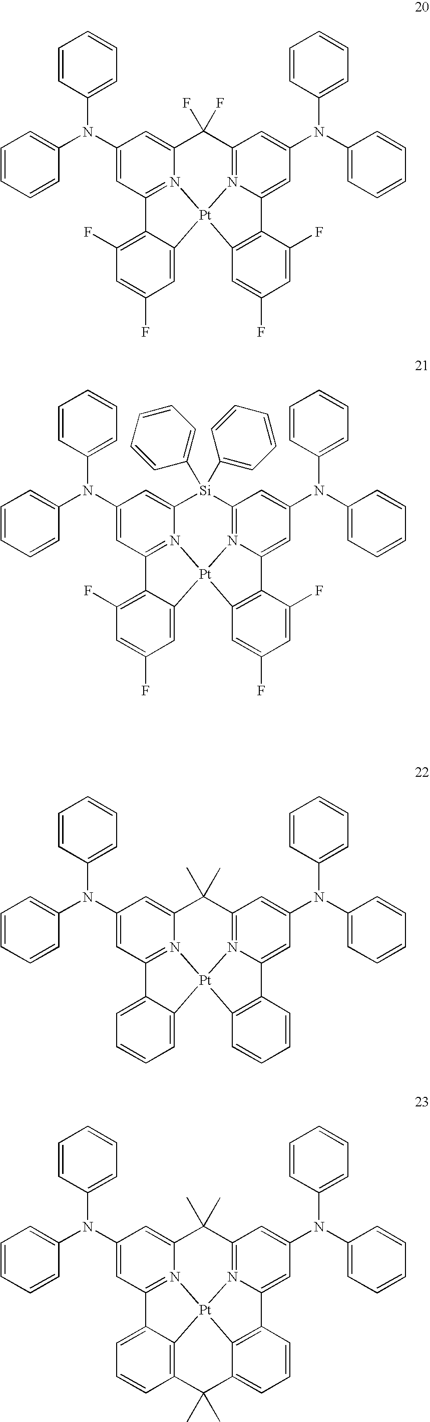

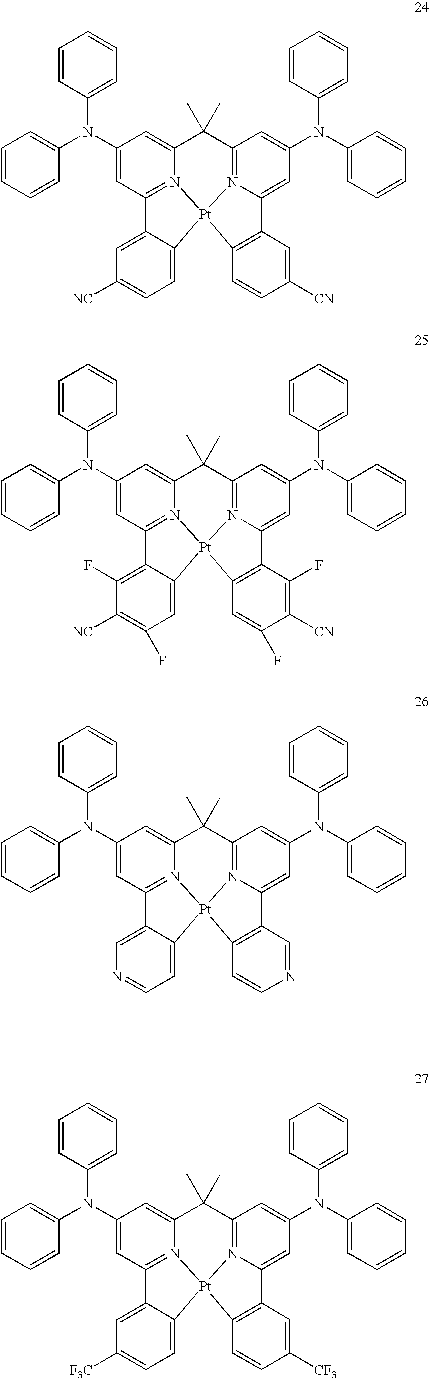

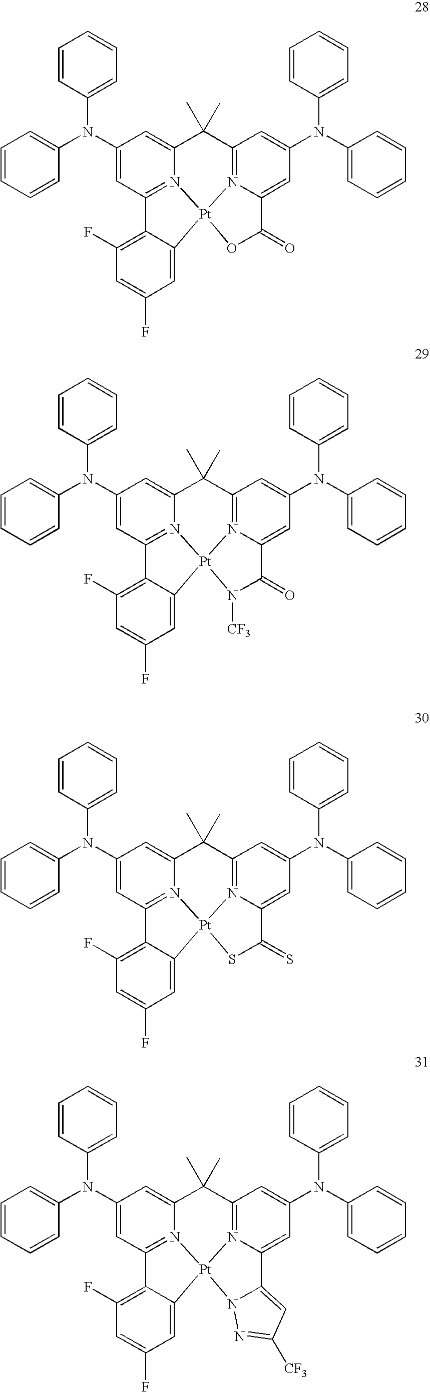

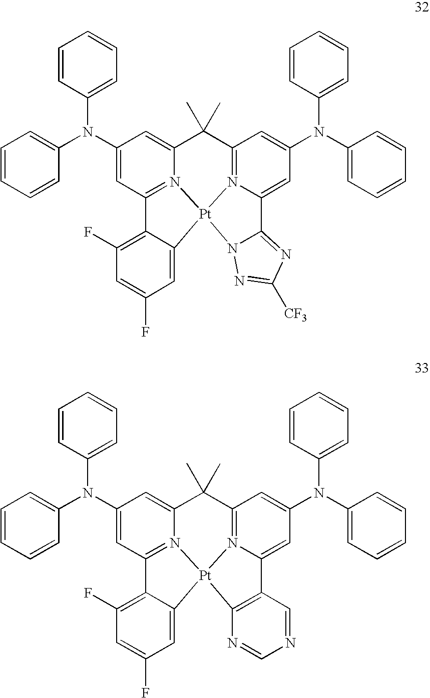

The compound represented by formula (I) may be a low molecular compound, or may be an oligomer compound or polymer compound (weight-average molecular weight (as polystyrene) is preferably 1000 to 5000000, more preferably 2000 to 1000000, and even more preferably 3000 to 1000000). When the compound represented by formula (I) is a polymer compound, the structure represented by formula (I) may be contained in a polymer main chain, or in a polymer side chain. In addition, the polymer compound may be a homopolymer or a copolymer. The compound of the invention is preferably a low molecular compound.

Specific examples of the polymer compound and oligomer compound including the structure represented by formula (I) are illustrated below, however the present invention is not limited thereto. The copolymer may be any one of a random copolymer, an alternative copolymer, and a block copolymer. In chemical formulae, m:n represents a mole ratio of each monomer contained in a polymer, m and n respectively represent numerical values of 1 to 100 and 0 to 99, and a sum of m and n is 100.

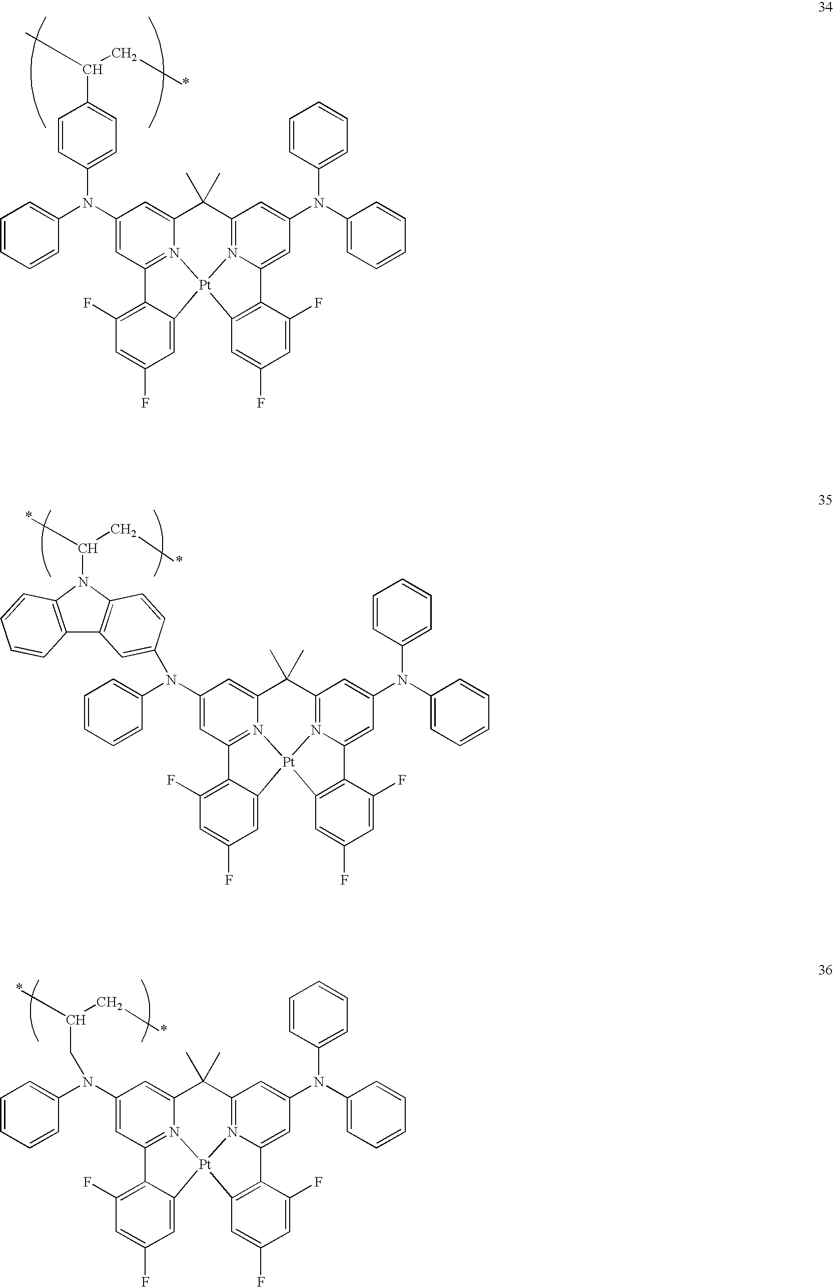

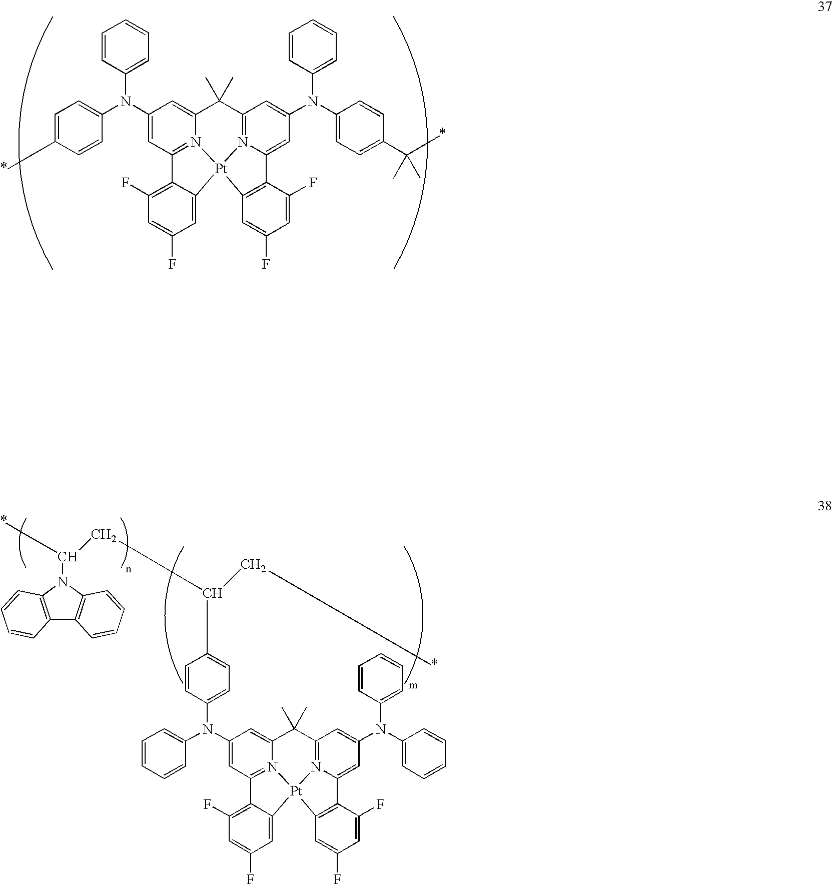

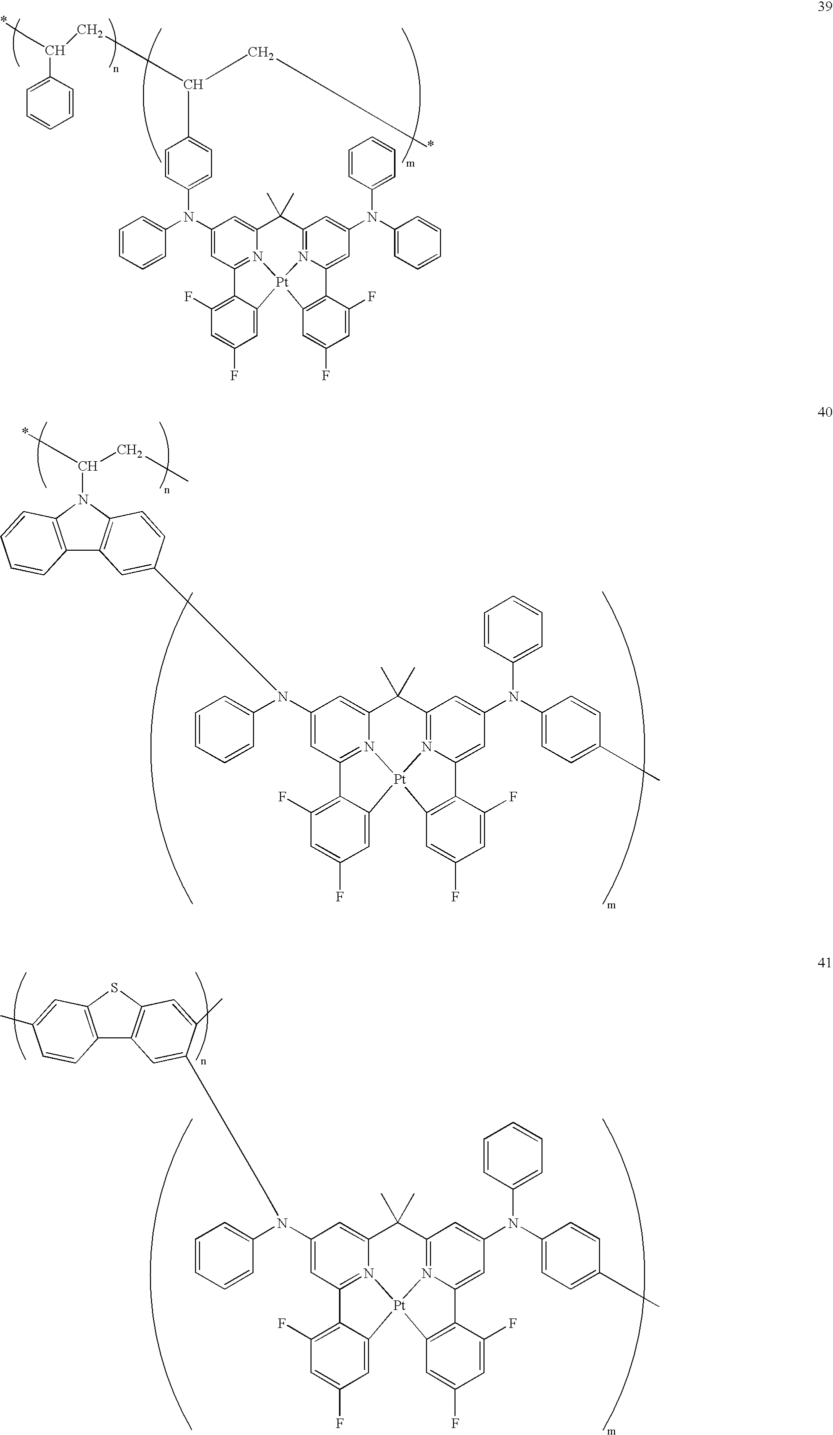

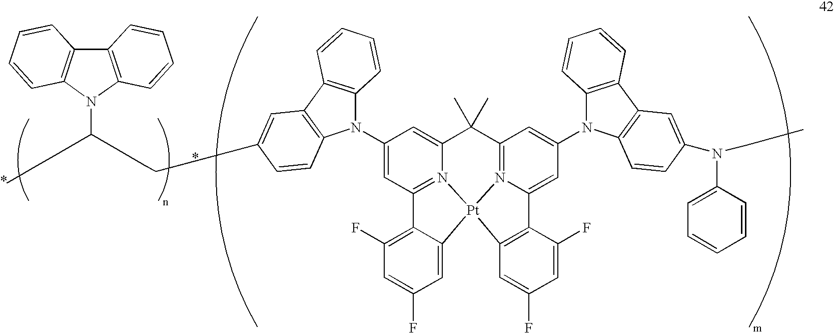

Hereinafter, methods for synthesizing the compound represented by formula (I) will be described, however the present invention is not limited to the methods.

The complex (i.e., the compound represented by formula (I)) can be synthesized by mixing a ligand with a metal source (for example, platinum chloride, palladium chloride, potassium platinum chloride, sodium palladium chloride, platinum bromide, platinum acetylacetone complex, etc.) under existence or non-existence of a solvent (acetonitrile, benzonitrile, acetic acid, ethanol, methoxyethanol, glycerol, water, or a mixture solvent thereof, etc.). An additive (trifluoromethane silver sulfide, pyridine, triethylamine, etc.) for accelerating the reaction may be added thereto, or the reaction may be performed under existence of inert gas (nitrogen, argon, etc.).

A reaction temperature is not particularly limited, but is preferably in the range of −30° C. to 400° C., more preferably in the range of 0° C to 350° C., and even more preferably in the range of 25° C. to 300° C.

The synthetic method will be described in further details in ‘Example’ section with reference to an Exemplary Compound 1. The other compounds of the invention can be synthesized in a similar manner as in Exemplary Compound 1.

Detailed explanations will be given regarding the each element constituting a device of the invention.

<Substrate>

A substrate to be used in the invention is preferably a substrate which does not scatter or attenuate light emitted from the organic layer. Specific examples include inorganic materials such as yttria-stabilized zirconia (YSZ), and glass; polyesters such as polyethylene terephthalate, polybutylene phthalate, and polyethylene naphthalate; and organic materials such as polystyrene, polycarbonate, polyethersulfone, polyallylate, polyimide, polycycloolefin, norbornene resins, poly(chlorotrifluoroethylene), and the like.

For example, when glass is used for the substrate, it is preferable to use a non-alkali glass as the substrate material, in order to reduce the ions eluting from the glass. Also, when soda lime glass is used, it is preferable to use one having a barrier coat such as silica or the like. When using the organic materials, these are preferably excellent in heat resistance, dimensional stability, solvent resistance, electrical insulating property and processability.

The shape, structure, size and the like of the substrate are not particularly limited and can be appropriately selected in accordance with the intended use, purpose and the like of the light-emitting device. In general, the substrate is preferably a plate-shape. The structure of the substrate may be either a monolayer structure or a layered structure. Further, the substrate may be made of a single material or of two or more materials.

The substrate may be colorless and transparent, or colored and transparent, but a colorless and transparent substrate is preferable from the viewpoint of not scattering or attenuating the light emitted from the organic light-emitting layer.

The substrate can be provided with a layer preventing moisture permeation (gas barrier layer) on the surface or the back surface.

As for the material of the layer preventing moisture permeation (gas barrier layer), inorganic substances such as silicon nitride, silicon oxide or the like are suitably used. The layer preventing moisture permeation (gas barrier layer) can be formed, for example, by high frequency sputtering or the like. When a thermoplastic substrate is used, a hard coat layer, an undercoat layer or the like may be further provided, if necessary.

<Anode>

In general, as for an anode, ones having a function as an electrode for supplying holes to the organic layers would be sufficient. There is no limitation on the shape, structure, size or the like, and the material can be appropriately selected from known electrode materials depending on the intended use and purpose of the light-emitting device. As described above, the anode is typically furnished as a transparent anode.

Examples of the material for the anode include metals, alloys, metal oxides, electroconductive compounds or mixtures thereof. Specific examples of the anode material include electroconductive metal oxides such as tin oxide (ATO, FTO) doped with antimony or fluorine, tin oxide, zinc oxide, indium oxide, indium tin oxide (ITO), and indium zinc oxide (IZO); metals such as gold, silver, chromium, and nickel; as well as mixture or layered product of such metals and electroconductive metal oxides; inorganic electroconductive materials such as copper iodide, and copper sulfate; organic electroconductive materials such as polyaniline, polythiophene, and polypyrrole; and layered product of these substances with ITO. Preferably electroconductive metal oxides and particularly ITO are preferable from the viewpoint of productivity, high electric conductivity, transparency, etc.

The anode can be formed on the substrate according to a method appropriately selected from, in consideration of the suitability to the material constituting the anode, for example, wet methods such as printing and coating, physical methods such as vacuum deposition, sputtering and ion plating, and chemical methods such as CVD and plasma CVD. For example, when ITO is selected as the material for anode, formation of the anode can be carried out by direct current sputtering or high frequency sputtering, vacuum deposition, ion plating or the like.

In the organic electroluminescent device of the invention, the anode can be formed in any part of the light-emitting device selected according to the intended use and purpose thereof, without particular limitation. However, it is preferred that the anode is formed on the substrate. In this case, the anode may be formed on the entire surface of one side of the substrate, or in a part of that surface.

Moreover, patterning in the formation of an anode may be carried out by means of chemical etching involving photolithography or the like, or by means of physical etching involving laser or the like. Further, it may also be carried out by a vacuum deposition or sputtering with masking, or may be carried out by a lift-off method or printing method.

The thickness of the anode can be appropriately selected in accordance with the material constituting the anode and thus cannot be indiscriminately defined. It is generally from 10 nm to 50 μm, and preferably from 50 nm to 20 μm.

The resistance value of the anode is preferably 10³Ω/sq or less, and more preferably 10² Ω/sq or less. When the anode is transparent, it may be colorless and transparent, or colored and transparent. In order to obtain luminescence from the transparent anode side, the transmissivity is preferably 60% or higher, and more preferably 70% or higher.

In addition, a transparent anode is described in detail in “Tohmeidenkyokumaku No Shintenkai (New Development of Transparent Electrode Films)” supervised by Yutaka Sawada, CMC Inc. (1999), the description of which can be applied to the invention. In case of using a plastic substrate with low heat resistance, it is preferable to employ ITO or IZO and a transparent anode film formed at a low temperature of 150° C. or below.

<Cathode>

In general, as for a cathode, ones having a function as an electrode for injecting electrons to the organic layers would be sufficient. There is no limitation on the shape, structure, size or the like, and the material can be appropriately selected from known electrode materials depending on the intended use and purpose of the light-emitting device.

Examples of the material constituting the cathode include metals, alloys, metal oxides, electroconductive compounds or mixtures thereof. Specific examples include alkali metals (e.g., Li, Na, K, Cs, etc.), alkaline earth metals (e.g., Mg, Ca, etc.), gold, silver, lead, aluminum, sodium-potassium alloys, lithium-aluminum alloys, magnesium-silver alloys, indium, rare earth metals such as ytterbium. They may be used individually, or from the viewpoint of achieving both stability and electron injection property, they may be suitably used in combination of two or more types.

Among these, as for the material constituting the cathode, alkali metals or alkaline earth metals are preferred from the viewpoint of the electron injection property, and materials mainly comprising aluminum are preferred from the viewpoint of excellent storage stability. The materials mainly comprising aluminum are aluminum itself, alloys comprising aluminum and 0.01 to 10% by mass of alkali metals or alkaline earth metals, or mixtures thereof (for example, lithium-aluminum alloys, magnesium-aluminum alloys, etc.).

In addition, the materials for the cathode are described in detail in JP-A-2-15595 and JP-A-5-121172, the descriptions of which are applicable to the invention.

The method of forming a cathode is not particularly limited and can be carried out according to a known method. The cathode can be formed according to a method appropriately selected from, in consideration of the suitability to the material constituting the cathode, for example, wet methods such as printing and coating, physical methods such as vacuum deposition, sputtering and ion plating, and chemical methods such as CVD and plasma CVD. For example, when metal or the like is selected as the material for cathode, formation of the cathode can be carried out by simultaneous or successive sputtering of one, or two or more types thereof.

Moreover, patterning in the formation of a cathode may be carried out by means of chemical etching involving photolithography or the like, or by means of physical etching involving laser or the like. Further, it may also be carried out by a vacuum deposition or sputtering with masking, or may be carried out by a lift-off method or printing method.

In the invention, the cathode can be formed in any part without particular limitation, and may be formed all over the organic layer, or in a part thereon.

Further, a dielectric layer of 0.1 to 5 nm in thickness, comprising a fluoride, oxide or the like of an alkali metal or an alkaline earth metal may be inserted in between the cathode and the organic layer. This dielectric layer can be seen as a type of electron injecting layer. The dielectric layer can be formed by, for example, vacuum deposition, sputtering, ion plating or the like.

The thickness of the cathode can be appropriately selected in accordance with the material constituting the cathode and thus cannot be indiscriminately defined. It is generally from 10 nm to 5 μm, and preferably from 50 nm to 1 μm.

Also, the cathode may be transparent or opaque. In addition, a transparent cathode can be formed by forming a film of a cathode material having a thickness of 1 to 10 nm and further stacking thereon a transparent electroconductive material such as ITO or IZO.

<Organic Layer>

The organic layer of the invention will be described. The device of the invention at least contains an organic layer including a light-emitting layer, and examples of other organic layers other than the organic light-emitting layer include above-mentioned, a hole transport layer, an electron transport layer, a hole blocking layer, a charge blocking layer, a hole injecting layer, an electron injecting layer, and the like.

-Formation of Organic Layer-

In the organic electroluminescent device of the invention, each layer constituting the organic layer can be suitably formed by a dry film forming method such as a vapor deposition or sputtering, a transcription method, a printing method, or the like.

-Light-emitting Layer-

The light-emitting layer is a layer having the function of emitting light by accepting holes from the anode, the hole injecting layer or the hole transport layer and accepting electrons from the cathode, the electron injecting layer or the electron transport layer upon application of an electric field, and providing a site for rebonding of the holes and the electrons.

The light-emitting layer according to the invention may only contain a light-emitting material, or may contain a mixture of host material and light-emitting material. The light-emitting material may be a fluorescent material or a phosphorescent material, and dopants may be used alone or in combination of two or more kinds thereof. The host material is preferably a charge transport material. The host material may be used alone, or in combination of two or more kinds, and an example includes a mixture constitution comprising an electron transport host material and a hole transport host material. Further, the light-emitting layer may not have the charge transport property, and contain a material not emitting light. The light-emitting layer preferably employs the complex of the invention, and constitutes at least one kind of host material and a complex of the invention.

In addition, the light-emitting layer may be a single layer or a multilayer of two or more layers, and the respective layers may emit lights of different colors.

Examples of the fluorescent material which can be used in the invention include benzoxazole derivatives, benzimidazole derivatives, benzothiazole derivatives, styryl benzene derivatives, polyphenyl derivatives, diphenyl butadiene derivatives, tetraphenyl butadiene derivatives, naphthalimide derivatives, coumarin derivatives, condensed aromatic compounds, perinone derivatives, oxadiazole derivatives, oxazine derivatives, aldazine derivatives, pyralizine derivatives, cyclopentadiene derivatives, bis-styryl anthracene derivatives, quinacridone derivatives, pyrrolopyridine derivatives, thiadiazolopyridine derivatives, cyclopentadiene derivatives, styryl amine derivatives, diketopyrrolopyrrole derivatives, aromatic dimethylidene compounds, various kinds of complexes represented by complexes of 8-quinolinol derivative and complexes of pyrromethane derivative, polymer compounds such as polythiophene, polyphenylene and polyphenylene vinylene, and compounds such as organic silane derivative, etc.

Examples of the phosphorescent material which can be used in the invention, other than the complexes of the invention, include a complex including a transition metal atom or a lanthanoid atom.

The transition metal atom is not particularly limited but may be preferably exemplified by ruthenium, rhodium, palladium, tungsten, rhenium, osmium, iridium and platinum, and more preferably by rhenium, iridium and platinum.

The lanthanoid atom may be exemplified by lanthanum, cerium, praseodymium, neodymium, samarium, europium, gadolinium, terbium, dysprosium, holmium, erbium, thulium, ytterbium and lutetium. Among these lanthanoid atoms, neodymium, europium and gadolinium are preferred.

Examples of the ligand of the complex include the ligands disclosed in G. Wilkinson et al, Comprehensive Coordination Chemistry, Pergamon Press (1987); H. Yersin, “Photochemistry and Photophysics of Coordination Compounds,” Springer-Verlag (1987); Akio Yamamoto, “Yukikinzokukagaku-Kiso to Oyo (Organometallic Chemistry-Fundamentals and Applications),” Shokabo (1982); and the like.

Specific examples of the ligand include preferably halogen ligands (preferably a chlorine ligand), nitrogen-containing heterocyclic ligands (e.g., phenyl pyridine, benzoquinoline, quinolinol, bipyridyl, phenanthroline, etc.), diketone ligands (e.g., acetylacetone, etc.), carboxylic acid ligands (e.g., acetic acid ligand, etc.), carbon monoxide ligand, isonitrile ligand, and cyano ligand, and more preferably nitrogen-containing heterocyclic ligands. The above-mentioned complex may have one transition metal atom in the compound, and may also be a so-called multinuclear complex having two or more of such atoms. It may also contain metal atoms of different types simultaneously.

The phosphorescent material is contained in the light-emitting layer in an amount of preferably from 0.1 to 40% by mass (weight), and more preferably from 0.5 to 20% by mass.

Examples of the host material contained in the light-emitting layer according to the invention include compounds having a carbazole skeleton, a diarylamine skeleton, a pyridine skeleton, a pyrazine skeleton, a triazine skeleton or an arylsilane skeleton, or materials exemplified for the hole injecting layer, the hole transport layer, the electron injecting layer, and the electron transport layer, which will be described later.

The thickness of the light-emitting layer is not particularly limited, but in general it is preferably from 1 nm to 500 nm, more preferably from 5 nm to 200 nm, and even more preferably from 10 nm to 100 nm.

-Hole Injecting Layer, Hole Transport Layer-

The hole injecting layer and the hole transport layer are layers having a function of accepting holes from the anode or the anode side and transporting them to the cathode side. Specifically, the hole injecting layer and the hole transport layer are preferably the layers containing carbazole derivatives, triazole derivatives, oxazole derivatives, oxadiazole derivatives, imidazole derivatives, polyarylalkane derivatives, pyrazoline derivatives, pyrazolone derivatives, phenylenediamine derivatives, arylamine derivatives, amino-substituted chalcone derivatives, styrylanthracene derivatives, fluorenone derivatives, hydrazone derivatives, stilbene derivatives, silazane derivatives, aromatic tertiary amine compounds, styrylamine compounds, aromatic dimethylidene type compounds, porphyrin type compounds, organic silane derivatives, carbon or the like.

The thicknesses of the hole injecting layer. and the hole transport layer are each preferably 500 nm or less, from the viewpoint of lowering the driving voltage.

The thickness of the hole transport layer is preferably from 1 to 500 nm, more preferably from 5 to 200 nm, and even more preferably from 10 to 100 nm. Also, the thickness of the hole injecting layer is preferably from 0.1 to 200 nm, more preferably from 0.5 to 100 nm, and even more preferably from 1 to 100 nm.

The hole injecting layer and the hole transport layer may be of single-layered structure comprising one, or two or more types of the above-mentioned materials, or may be of a multilayered structure including a plurality of layers having the same composition or different compositions.

-Electron Injecting Layer, Electron Transport Layer-

The electron injecting layer and the electron transport layer are layers having a function of accepting electrons from the cathode or the cathode side and transporting them to the anode side. Specifically, the electron injecting layer and the electron transport layer are preferably layers containing triazole derivatives, oxazole derivatives, oxadiazole derivatives, imidazole derivatives, fluorenone derivatives, anthraquinodimethane derivatives, anthrone derivatives, diphenylquinone derivatives, thiopyran dioxide derivatives, carbodiimide derivatives, fluorenylidenemethane derivatives, distyrylpyrazine derivatives, aromatic ring tetracarboxylic acid anhydrides(such as naphthalene and perylene), phthalocyanine derivatives, various complexes such as complexes of 8-quinolinol derivatives, metallophthalocyanines, and complexes having benzoxazole or benzothiazole as a ligand, organic silane derivatives or the like.

The thicknesses of the electron injecting layer and the electron transport layer are each preferably 50 nm or less from the viewpoint of lowering the driving voltage.

The thickness of the electron transport layer is preferably from 1 to 500 nm, more preferably from 5 to 200 nm, and even more preferably from 10 to 100 nm. Also, the thickness of the electron injecting layer is preferably from 0.1 to 200 nm, more preferably from 0.2 to 100 nm, and even more preferably from 0.5 to 50 nm.

The electron injecting layer and the electron transport layer may be of a single-layered structure comprising one or two of more types of the above-mentioned materials, or may be of a multilayered structure including a plurality of layers having the same composition or different compositions.

-Hole Blocking Layer-

The hole blocking layer is a layer having a function of limiting the migration of holes, which are transported to the light-emitting layer from the anode side, to the cathode side. In the invention, the hole blocking layer can be employed as the organic layer adjacent to the cathode side of the light-emitting layer.

Examples of the organic compounds constituting the hole blocking layer include aluminum complexes such as BAlq, triazole derivatives, phenanthroline derivatives such as BCP.

The thickness of the hole blocking layer is preferably from 1 to 500 nm, more preferably from 5 to 200 nm, and even more preferably from 10 to 100 nm.

The hole blocking layer may be of a single-layered structure comprising one or two or more types of the above-mentioned materials, or may be of a multilayered structure including a plurality of layers having the same composition or different compositions.

<Protective Layer>

In the invention, the organic EL device as a whole may be protected by a protective layer.

The materials contained in the protective layer may be any materials having a function of preventing the factors which promote device deterioration such as moisture or oxygen from entering into the device.

Specific examples thereof include metals such as In, Sn, Pb, Au, Cu, Ag, Al, Ti, and Ni, metal oxides such as MgO, SiO, SiO₂, Al₂O₃, GeO, NiO, CaO, BaO, Fe₂O₃, Y₂O₃, and TiO₂, metal nitrides such as SiNₓ and SiNₓO_{y}, metal fluorides such as MgF₂, LiF, AlF₃ and CaF₂, polyethylene, polypropylene, polymethyl methacrylate, polyimide, polyurea, polytetrafluoroethylene, polychlorotrifluoroethylene, polydichlorodifluoroethylene, copolymers of chlorotrifluoroethylene and dichlorodifluoroethylene, copolymers obtainable by a copolymerization of monomer mixture including tetrafluoroethylene and at least one comonomer, fluorine-containing copolymers having a cyclic .structure in the copolymer main chain, absorbent materials having an absorption rate of 1% or more, and moisture-resistant materials having an absorption rate of 0.1% or less.

The method of forming the protective layer is not particularly limited, and for example, a vacuum deposition method, sputtering, a reactive sputtering method, an MBE (molecular beam epitaxy) method, a cluster ion beam method, an ion plating method, a plasma polymerization method (high frequency-excited ion plating), a plasma CVD method, a laser CVD method, a thermal CVD method, a gas source CVD method, a coating method, a printing method, and a transcription method.

<Sealing>

Moreover, the device of the invention may be sealed for the entire device using a sealing vessel. Also, a space between the sealing vessel and the device may be sealed with a moisture absorbent or an inactive liquid. The moisture absorbent, though not particularly limited, may be exemplified by barium oxide, sodium oxide, potassium oxide, calcium oxide, sodium sulfate, calcium sulfate, magnesium sulfate, phosphorous pentoxide, calcium chloride, magnesium chloride, copper chloride, cesium fluoride, niobium fluoride, calcium bromide, vanadium bromide, molecular sieves, zeolites, magnesium oxide or the like. The inactive liquid, though not particularly limited, may be exemplified by paraffins, liquid paraffins, fluorine type solvents such as perfluoroalkanes, perfluoroamines and perfluoroethers, chlorine type solvents, and silicone oils.

In the device of the invention, light emission can be achieved by applying a direct current (DC) (it may include an alternating current component, if desired) voltage (typically 2 volts to 15 volts) or a DC current between the anode and the cathode.

As for the method of driving the device of the invention, the methods disclosed in the publications of JP-A-2-148687, JP-A-6-301355, JP-A-5-29080, JP-A-7-134558, JP-A-8-234685 and JP-A-8-241047, in the specifications of Japanese Patent No. 2784615, U.S. Pat. Nos. 5,828,429 and 6,023,308, and the like can be applied.

The light-emitting device of the invention is preferably applied in display devices, displays, backlights, electrophotographs, illuminating light sources, recording light sources, exposing light sources, reading light sources, markers, signboards, interiors, optical communications, etc. Further, the complex compounds of the invention can be applied in a medical use, fluorescent whitening agents, photographic materials, UV absorbents, laser dyes, materials for recording media, colorants for inkjet, colorants for colorfilter, color conversion filters, etc.

Hereinafter, the invention will be described in more detail by reference to the following Examples. However, the present invention is not limited thereto.

### SYNTHETIC EXAMPLE

### Synthesis of Exemplary Compound 1

Exemplary Compound 1 is synthesized according to the following scheme. 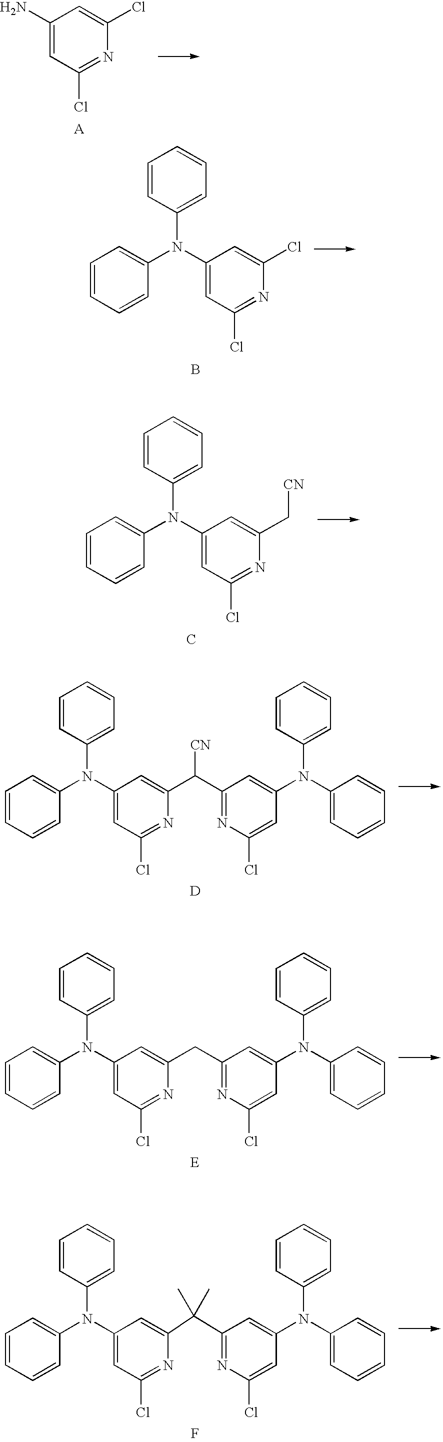 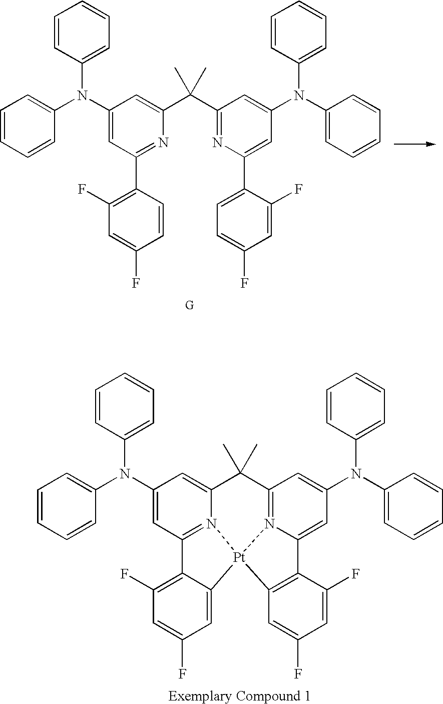
Synthesis of Compound B

Tri-tert-butylphosphine (0.3ml) and bromobenzene (9.4ml) were added to a mixture of Compound A (5.0 g), palladium acetate (73 mg), sodium-tert-butoxide (11.5 g) and xylene (20 ml) under nitrogen flow, and then heated at 150° C. for 3 hours. After cooling to the room temperature, water was added and the mixture was extracted with ethyl acetate, and then an organic layer was dried over magnesium sulfate and the ethyl acetate was distilled. Obtained rough product was refined by silica gel column chromatography (hexane:ethyl acetate=20:1) to obtain 3.13 g of Compound B (32% yield).

Synthesis of Compound C

Tetrahydrofuran (5 ml) was cooled by dry ice, and 10 M hexane solution (0.36 ml) of n-butyllithium and acetonitrile were subsequently added thereto under nitrogen flow. After being stirred for 10 minutes, tetrahydrofuran solution (4 ml) of Compound B (0.31 g) was added and a temperature was increased to the room temperature. Saturated ammonium chloride solution was added and the mixture was extracted with ethyl acetate, and then an organic layer was dried over magnesium sulfate and the ethyl acetate was distilled. Obtained rough product was refined by silica gel column chromatography (hexane:ethyl acetate=4:1) to obtain 0.28 g of Compound C (87% yield).

Synthesis of Compound D

Compound B (0.43 g), Compound C (0.33 g) and potassium hydroxide (0.27 g) were dissolved in methylsulfoxide (4 ml), and heated at 100° C. for 20 minutes. After cooling to the room temperature, diluted hydrochloric acid was added and the mixture was extracted with ethyl acetate, and then an organic layer was dried over magnesium sulfate and the ethyl acetate was distilled. Obtained rough product was refined by silica gel column chromatography (hexane:ethyl acetate=10:1 to 5:1) to obtain 0.33 g of Compound D (55% yield).

Synthesis of Compound E

Compound D (0.33 g) was dissolved in concentrated hydrochloric acid (4 ml) and isopropyl alcohol (4 ml), and heated at reflux for 5 hours. After the cooling, it was neutralized with sodium hydrogencarbonate solution and the mixture was extracted with ethyl acetate, and then an organic layer was dried over magnesium sulfate and the ethyl acetate was distilled. Obtained rough product was refined by silica gel column chromatography (hexane:ethyl acetate=9:1 to 4:1) to obtain 0.23 g of Compound E (40% yield).

Synthesis of Compound F

Compound E (0.20 g) was dissolved in tetrahydrofuran (5 ml), and 1.8M tetrahydrofuran-ethylbenzene-heptane solution (0.3 ml) of lithium diisopropyl amide was added thereto while being cooled in an ice bath, subsequently 0.35M tetrahydrofuran solution (1 ml) of methyl iodide was added. After repeating this process once more, water was added and the mixture was extracted with ethyl acetate, and then an organic layer was dried over magnesium sulfate and the ethyl acetate was distilled. Obtained rough product was refined by silica gel column chromatography (ethyl acetate) to obtain 0.17 g of Compound F (81% yield).

Synthesis of Compound G

Potassium carbonate (0.31 g) solution (1 ml) was added to a mixture of Compound F (0.17 g), 2,4-difluorophenyl boric acid (0.18 g), palladium acetate (6.3 mg), triphenylphosphine (29 mg) and xylene (5 ml) under a nitrogen atmosphere, and stirred for 4 hours. After cooling to the room temperature, the mixture was extracted with ethyl acetate, and then an organic layer was dried over magnesium sulfate and the ethyl acetate was distilled. Obtained rough product was refined by silica gel column chromatography (hexane : ethyl acetate=9:1) to obtain 84 mg of Compound G (40% yield).

Synthesis of Exemplary Compound 1

A mixture of Compound G (84 mg), platinum chloride (35 mg) and benzonitrile (10 ml) was stirred at 160° C. for 4 hours, under nitrogen flow. The benzonitrile was distilled, and obtained rough product was refined by silica gel column chromatography (methylene chloride) to obtain 62 mg of Exemplary Compound 1 (60% yield).

<Preparation and Evaluation of Organic Electroluminescent Device>

1. Preparation of Organic Electroluminescent Device

(1) Preparation of Organic Electroluminescent Device of the Invention (TC-21)

A glass substrate (manufactured by Geomatec Co., Ltd., having a surface resistance of 10 Ω/sq) of 0.5 mm in thickness and 2.5 cm square with ITO film was put in a cleaning container, ultrasonically cleaned in 2-propanol, and treated by UV ozone for 30 minutes. On this transparent anode (ITO film), following organic compound layers were vapor-deposited in the order by vacuum deposition method.

A deposition rate in Examples of the invention is from 0.1 to 2 nm/sec, unless otherwise specified. The deposition rate was measured by using a quartz crystal. The thicknesses of films listed below were also measured by using the quartz crystal.

(Hole Injecting Layer)

Copper phthalocyanine (CuPc): film thickness 10 nm (Hole Transport Layer)

NPD: film thickness 40 nm

(Light-emitting layer)

MCP=92% by mass, Exemplary Compound 1=a mixture layer of 8% by mass film thickness 30 nm

(Electron Transport Layer)

Balq: film thickness 10 nm

(Electron Injecting Layer)

Alq: film thickness 10 nm

Chemical structures of above-mentioned CuPc, NPD, MCP, Balq, and Alq are shown below.

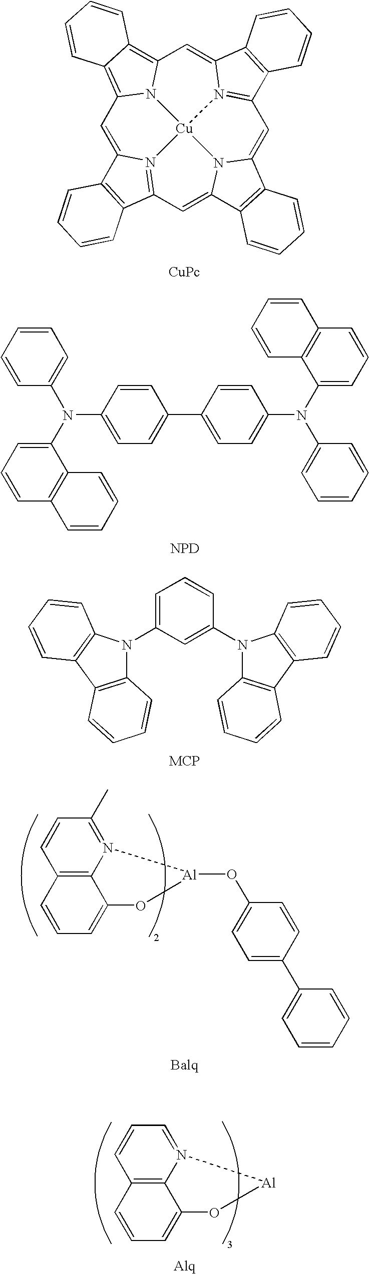

Finally, 0.1 nm of lithium fluoride and metallic aluminum were subsequently deposited by 100 rim to form a cathode. This was then put in a glove box replaced by argon gas without being contacted to the air, and was sealed by using a stainless steel-sealing can and an adhesive of ultraviolet curing type (XNR5516HV, manufactured by Nagase Ciba) to obtain the organic electroluminescent device (TC-21).

(2) Preparation of organic electroluminescent device (TC-22) of Comparative Example

The organic electroluminescent device (TC-22) was prepared in the same manner as in TC-21 , except that the light-emitting material was replaced from Exemplary Compound 1 to the following Comparative Compound 1 disclosed in International Publication brochure No. 04/108857. 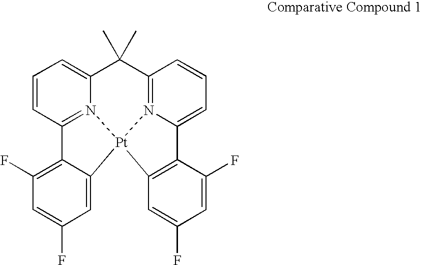
2. Evaluation of Organic Electroluminescent Device

When direct current constant voltage (5V) was applied to the obtained organic electroluminescent devices described above (TC-21 and TC-22), it was observed to emit blue-green light which is usually emitted by a phosphorescent emitter.

Highest luminance and driving durability of TC-21 were 1.5 times that of the TC-22.

From the examples described above, it was revealed that highly efficient and highly durable organic electroluminescent devices were obtained by using the compound of the invention (Exemplary Compound 1). In addition, same effects can be achieved by using the other compounds of the invention.

It will be apparent to those skilled in the art that various modifications and variations can be made to the described embodiments of the invention without departing from the spirit or scope of the invention. Thus, it is intended that the invention cover all modifications and variations of this invention consistent with the scope of the appended claims and their equivalents.

The present application claims foreign priority based on Japanese Patent Application No. JP2005-262305 filed Sep. 9 of 2005, the contents of which is incorporated herein by reference.

What is claimed is:

1. An organic electroluminescent device comprising:
a pair of electrodes; and
at least one organic layer between the pair of electrode, the at least one organic layer including a light-emitting layer, wherein the at least one organic layer contains at least one compound represented by formula (I): 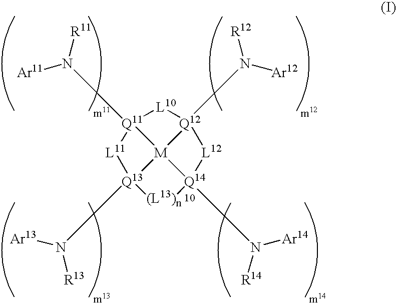
wherein M represents a metal ion; Q¹¹, Q¹², Q¹³, and Q¹⁴ each independently represent an atom group coordinating with M; L¹⁰, L¹¹, L¹², and L¹³ each independently represent a single bond, a double bond or a linking group; lines between the M and each of Q¹¹, Q¹², Q¹³, and Q¹⁴ represent one of a covalent bond, an ionic bond, and a coordinate bond; n¹⁰ is 0 or 1, and when n¹⁰=0, Q¹³ and Q¹⁴ do not bond to each other; m¹¹, m¹², m¹³ and m¹⁴ each independently are an integer of 0 or more, and at least one of m¹¹, m¹², m¹³ and m¹⁴ is 1 or more; Ar¹¹, Ar¹², Ar¹³ and Ar¹⁴ each independently represent an aryl group or a heteroaryl group; and R¹¹, R¹², R¹³, and R¹⁴ each independently represent a hydrogen atom or a substituent group.

2. The organic electroluminescent device according to claim 1, wherein the metal ion represented by M in formula (I) is an ion selected from the group consisting of a platinum ion, an iridium ion, a rhenium ion, a palladium ion, a rhodium ion, a ruthenium ion, and a copper ion.

3. The organic electroluminescent device according to claim 2, wherein the metal ion represented by M in formula (I) is an ion selected from the group consisting of a platinum ion, an iridium ion, a palladium ion, and a rhodium ion.

4. The organic electroluminescent device according to claim 3, wherein the substituent group in formula (I) is an alkyl group, an aryl group, or a heteroaryl group.

5. The organic electroluminescent device according to claim 1, wherein the substituent group in formula (I) is an alkyl group, an aryl group, or a heteroaryl group.

6. The organic electroluminescent device according to claim 5, wherein the metal ion represented by M in formula (I) is an ion selected from the group consisting of a platinum ion, an iridium ion, a rhenium ion, a palladium ion, a rhodium ion, a ruthenium ion, and a copper ion.

7. The organic electroluminescent device according to claim 1, wherein the compound represented by formula (I) is a compound represented by formula (II): 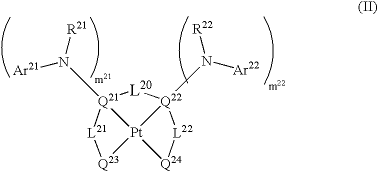
wherein Q²¹, Q²², Q²³, and Q²⁴ each independently represent an atom group coordinating with the platinum ion; L²⁰, L²¹, and L²² each independently represent a single bond, a double bond or a linking group; lines between the platinum ion and each of Q²¹, Q²², Q²³, and Q²⁴ represent one of a covalent bond, an ionic bond, and a coordinate bond; m²¹ and m²² each independently are an integer of 0 or more, and at least one of m²¹ and m²² is 1 or more; Ar²¹ and Ar²² each independently represent an aryl group or a heteroaryl group; and R²¹ and R²² each independently represent a hydrogen atom or a substituent group.

8. The organic electroluminescent device according to claim 7, wherein the substituent group in formula (II) is an alkyl group, an aryl group, or a heteroaryl group.

9. The organic electroluminescent device according to claim 7, wherein the compound represented by formula (I) is a compound represented by formula (III): 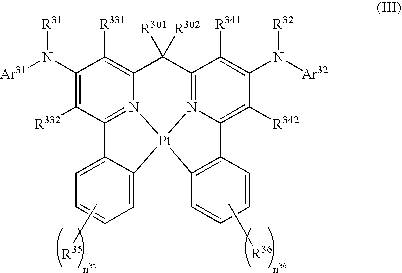
wherein lines between the platinum ion and the nitrogen atoms represent a coordinate bond; and lines between the platinum ion and the carbon atoms represent a covalent bond or an ionic bond; R³⁰¹ and R³⁰² each independently represent a hydrogen atom or a substituent group; Ar³¹ and Ar³² each independently represent an aryl group or a heteroaryl group; R³¹ and R³² each independently represent a hydrogen atom or a substituent group; R³³¹, R³³², R³⁴¹, and R³⁴² each independently represent a hydrogen atom or a substituent group; R³⁵ and R³⁶ independently each represent a substituent group; and n³⁵ and n³⁶ each independently represent an integer of 0 to 4.

10. The organic electroluminescent device according to claim 9, wherein the substituent group in formula (III) is an alkyl group, an aryl group, or a heteroaryl group.

11. A compound represented by formula (III): 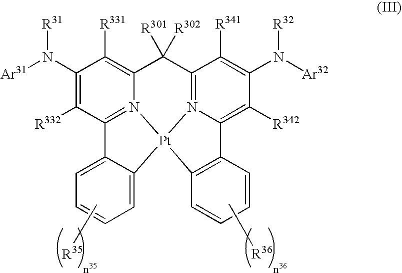
wherein lines between the platinum ion and the nitrogen atoms represent a coordinate bond; and lines between the platinum ion and the carbon atoms represent a covalent bond or an ionic bond; R³⁰¹ and R³⁰² each independently represent a hydrogen atom or a substituent group; Ar³¹ and Ar³² each independently represent an aryl group or a heteroaryl group; R³¹ and R³² each independently represent a hydrogen atom or a substituent group; R³³¹, R³³², R³⁴¹, and R³⁴² each independently represent a hydrogen atom or a substituent group; R³⁵ and R³⁶ independently each represent a substituent group; and n³⁵ and n³⁶ each independently represent an integer of 0 to 4.
